(19) United States
(12) Patent Application Publication
(10) Pub. No.: US 2016/0048543 A1
(43) Pub. Date: Feb. 18, 2016

(54) SYSTEM AND METHOD FOR DETERMINING GOVERNANCE EFFECTIVENESS OF KNOWLEDGE MANAGEMENT SYSTEM

(71) Applicant: Wipro Limited, Bangalore (IN)

(72) Inventors: Sreenivas Kunapuli, Hyderabad (IN); Anuradha Pentareddy, Hyderabad (IN)

(21) Appl. No.: 14/497,643

(22) Filed: Sep. 26, 2014

(30) Foreign Application Priority Data
Aug. 13, 2014 (IN) 3973/CHE/2014

(51) Int. Cl. G06F 17/30; G06N 5/04

(52) U.S. Cl. CPC G06F 17/30312; G06F 17/30371; G06N 5/046

(57) ABSTRACT

The present subject matter relates to a method, device and non-transitory computer readable medium for determining governance effectiveness of one or more knowledge artifacts. In one embodiment, governance effectiveness is determined by determining one or more parameters such as Intellectual Property IP effectiveness index, audit rights index, collaboration index, quality index of the knowledge artifacts. By determining the governance effectiveness of the knowledge artifacts, the system is able to continuously measure as to how the knowledge is being governed across various aspects like IP, Audit Rights, Collaboration and Quality on the knowledge artifacts. Further, the Knowledge management system is capable of adapting itself to the future changes or needs and also ensuring that the processes are being followed in line with standard protocols followed on the Knowledge trade.

This application claims the benefit of Indian Patent Application Serial No. 3973/CHE/2014 filed Aug. 13, 2014, which is hereby incorporated by reference in its entirety.

### FIELD

The present subject matter is related, in general to knowledge management system, and more particularly, but not exclusively to a method and a system for determining governance effectiveness of knowledge artifacts.

### BACKGROUND

Knowledge Management comprises a range of practices used by organizations to identify, create, represent, and distribute knowledge. Knowledge Management (KM) programs are typically tied to organizational objectives such as improved performance, competitive advantage, innovation, developmental processes, and the general development of collaborative practices. Knowledge management typically utilizes KM applications (e.g. software applications) to categorize, store, and search knowledge artifacts.

Knowledge artifacts are records of information, such as documents, that exist in a retrievable format for use by others. A knowledge artifact may be any memorialization (i.e. record) of information, such as, by way of non-limiting examples, a document, an audio recording, or a video recording. Information can be obtained from documents, interviews, or any other source. Knowledge is often captured and fragmented across a set of digital artifacts or files such as text files, images, binaries, source code, proprietary application files, and others. KM applications are generally usable to search for and retrieve records of knowledge artifacts so that they may be re-used or serve as examples for future reference. However, conventional KM applications do not continuously measure as to how the knowledge is being governed across various aspects like IP, Audit Rights, Collaboration and Quality on the knowledge artifacts.

Therefore, there is a need to provide a method and a system to measure the governance effectiveness of knowledge artifacts and enable effective decision making based on the governance effectiveness.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a computer-implemented method of determining governance effectiveness of knowledge management system. The method comprising accessing at least one metadata associated with the one or more knowledge artifacts and determining at least one of an Intellectual Property (IP) effectiveness index (IPI) score, an audit rights index (ARI) score, a collaboration index score, and quality index score using the at least one metadata of the one or more knowledge artifacts. Based on the at least one of the IP effectiveness index score, the audit rights index score, the collaboration index score, and the quality index score, a governance effectiveness index score of the knowledge management system is determined.

Further, the present disclosure relates to a computer-implemented system for. The system comprises a memory communicatively coupled to the processor, wherein the memory stores processor-executable instructions, which, on execution, cause the processor to determine at least one of an IP effectiveness index (IPI) score, an audit rights index (ARI) score, a collaboration index score, and quality index score using the at least one metadata of the one or more knowledge artifacts. The processor is further configured to determine a governance effectiveness index score of the knowledge management system based on the at least one of the IP effectiveness index score, the audit rights index score, the collaboration index score, and the quality index score.

Furthermore, the present disclosure relates to a non-transitory computer readable medium including instructions stored thereon that when processed by at least one processor cause a system to perform the acts of accessing at least one metadata associated with one or more knowledge artifacts. Further, the instructions cause the processor to perform the acts of determining at least one of an IP effectiveness index (IPI) score, an audit rights index (ARI) score, a collaboration index score, and quality index score using the at least one metadata of the one or more knowledge artifacts. Upon determining the at least one of the IP effectiveness index score, the audit rights index score, the collaboration index score, and the quality index score, the instructions further cause the processor to determine a governance effectiveness index score of a knowledge management system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for determining governance effectiveness index of knowledge artifacts in accordance with some embodiments of the present disclosure;

FIG. 2 illustrates a block diagram of a governance unit for determining governance effectiveness index of the knowledge artifacts in accordance with some embodiments of the present disclosure;

FIG. 3 illustrates a flowchart of a method of determining governance effectiveness index of the knowledge artifacts in accordance with some embodiments of the present disclosure;

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a computer-implemented method and a system for determining governance effectiveness of one or more knowledge artifacts. In one embodiment, governance effectiveness is determined by determining one or more parameters such as Intellectual Property (IP) effectiveness index, audit rights index, collaboration index, quality index of the knowledge artifacts. By determining the governance effectiveness of the knowledge artifacts, the system is able to continuously measure as to how the knowledge is being governed across various aspects like IP, Audit Rights, Collaboration and Quality on the knowledge artifacts. Further, the Knowledge management system is capable of adapting itself to the future changes or needs and also ensuring that the processes are being followed in line with standard protocols followed on the Knowledge trade.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

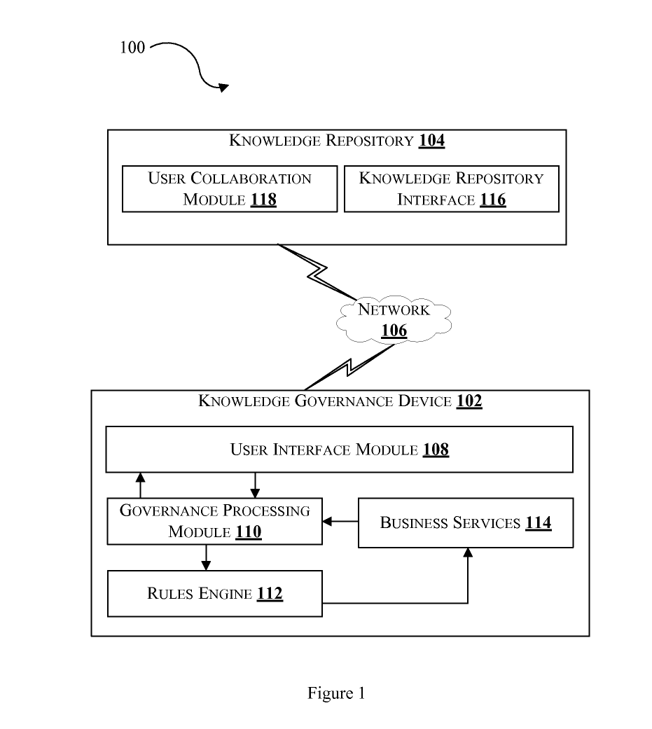

FIG. 1 illustrates architecture of system for determining governance effectiveness index of knowledge artifacts in accordance with some embodiments of the present disclosure.

As shown in FIG. 1, a system 100 for determining governance effectiveness index of knowledge artifacts comprises one or more components coupled with each other. In one implementation, the system 100 comprises a knowledge governance device 102 (hereinafter referred to as governance device 102) communicatively coupled with a knowledge repository 104 via a communication network 106.

The knowledge repository 104 refers to an electronic storage system that stores knowledge artifacts and dependencies for later retrieval. The stored knowledge artifacts are published in accordance with procedures which are well known to those in the field, so that artifacts made by one developer are published to be available for further use by other developers. The stored knowledge artifacts are incorporated as building blocks to build products which can be executed. In one embodiment, the knowledge repository 104 can include a computer server by which the stored electronic copies of knowledge artifacts are made available for use by developers to be incorporated as building blocks to build products which can be executed. The knowledge repository 104 has a unique identifier that indicates the developer (an individual or a group) that contributed the artifact. The knowledge repository 104 can be remote or local.

The knowledge repository 104 comprises a knowledge repository interface 116 to enable the governance device 102 to access the one or more knowledge artifacts stored in the knowledge repository 104. In one embodiment, the knowledge repository interface 116 provides user interface to one or more services provided by the knowledge repository 104. Example of services include Application services, Search services, Personalization services, Publishing services, Security and Infra services, and Notification services. The knowledge repository 104 also comprises a user collaboration module 118 configured to enable the users to collaborate on the one or more stored knowledge artifacts. The user collaboration module 118 update one or more modified or new knowledge artifacts in the knowledge repository 104 obtained during the user collaboration so that the governance device 102 access the one or more updated knowledge artifacts to determine the governance effectiveness of the updated knowledge artifacts.

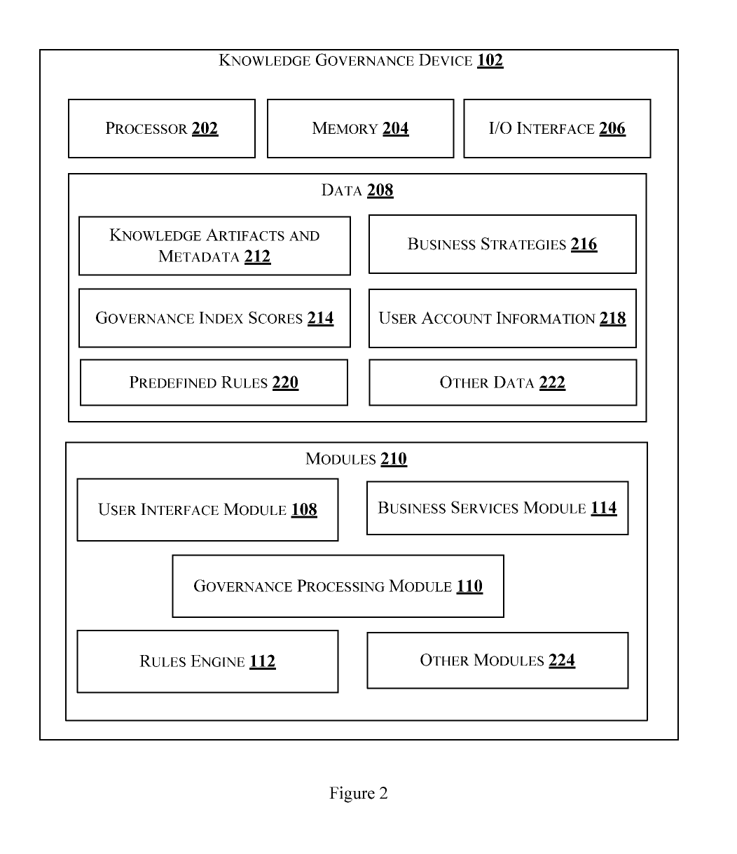

In one embodiment, the governance device 102 comprises a user interface module 108, a governance processing module 110, a rules engine 112 and a business services module 114. The governance device is one of the possible variations of the governance device 102 described in greater details below with reference to FIG. 2. In one implementation, the governance device 102, as shown in FIG. 2, includes a central processing unit (“CPU” or “processor”) 202, a memory 204 and an I/O interface 206. The I/O interface 206 is coupled with the processor 202 and an I/O device. The I/O device is configured to receive inputs via the I/O interface 206 and transmit outputs for displaying in the I/O device via the I/O interface 206.

The governance device 102 further comprises data 208 and modules 210. In one implementation, the data 208 and the modules 210 may be stored within the memory 204. In one example, the data 208 may include knowledge artifacts and associated metadata 212, governance index scores 214, business strategies 216, user account information 218, predefined rules 220 and other data 222. In one embodiment, the data 208 may be stored in the memory 204 in the form of various data structures. Additionally, the aforementioned data can be organized using data models, such as relational or hierarchical data models. The other data 222 may be used to store data, including temporary data and temporary files, generated by the modules 210 for performing the various functions of the governance device 102.

The modules 210 may include, for example, the user interface module 108, the governance processing module 110, the rules engine 112 and the business services module 114. The modules 210 may also comprise other modules 224 to perform various miscellaneous functionalities of the governance device 102. It will be appreciated that such aforementioned modules may be represented as a single module or a combination of different modules.

In operation, the knowledge repository 104 is accessed by one or more users to collaborate on the one or more knowledge artifacts stored therein. In one example, “user” is defined herein specifically, for example, to be a software developer, a line coder, a technical architect, a development lead, or a development manager who is running a team of one or more developers, any of which are working on a software deliverable; or a C-level individual (CIO, CSO, and the like); or an individual that sets or enforces governing standards for software deliverables such as for vulnerability or licensing or knowledge artifacts.

The user interface module 108 is configured to validate a user who wishes to access or collaborate on the one or more knowledge artifacts. In one embodiment, the user interface module 108 receives the login details or the user account information 218 of a user and authenticates the user to access one or more knowledge artifacts based on valid login information. The user is authenticated by comparing the user account information 218 received from the user with login information previously stored at the time of registering the user.

Upon validating the authenticity of the user, the user interface module 108 categorizes or classifies the user into one or more categories including Employee, Supplier, Customer, Investor, and so on. In another embodiment, the user may be categorized as one of Employee-Admin, Employee-SME and so on. Each categorized user may be assigned with one or more access controls on the one or more knowledge artifacts 212 determined by the rules engine 112. The rules engine 112 may be implemented by, for example, the processor 202 configured to determine the one or more access controls based on one or more predefined rules 220 and to assign the access controls to the categorized user.

Based on the access controls, the user may access or retrieve the one or more knowledge artifacts and associated metadata 212 from the knowledge repository 104. The term “metadata” is defined to be data that describes the content and context of a file with which the metadata is associated. For example, the metadata associated with a knowledge artifact can indicate a project to which the knowledge artifact belongs, a security of the knowledge artifact or a license that is associated with the knowledge artifact, among other things. The knowledge artifacts and the associated metadata 212 are then processed by the governance device 102 to determine the governance effectiveness of the one or more knowledge artifacts 212.

In one embodiment, the governance processing module 110 determines scores of the metadata associated with the knowledge artifacts 212 and determines the governance effectiveness index based on the one or more index scores thus determined. The governance processing module 110 may be implemented by the rules engine 112 or by the processor 202 and memory 204 in the governance device 102. The memory 204 may be operatively connected to the rules engine 112 or to the processor 202 and stores processor-executable instructions to implement the governance processing module 110. The rules engine 112 determines one or more governance index scores 214 using the metadata of the one or more knowledge artifacts 212 in any sequence or order. One or more governance index scores 214 include an Intellectual Property IP effectiveness index (IPI) score, an audit rights index (ARI) score, a collaboration index score, and quality index score.

### IP Effectiveness Index (IPI)

IP effectiveness index score is a measure of effectiveness of the one or more knowledge artifacts in terms of IP. In one implementation, the IP effectiveness index score is determined by the rules engine 112 based on one or more parameter including Completeness of process ownership, Ease of Sourcing Flexibility and Risk associated with the one or more knowledge artifacts 212.

### Process Ownership Index (POI)

The governance processing module 110 is configured to associate a user who is an employee of the organization as an owner with every knowledge artifact 212 published on the Knowledge repository 104. The governance processing module 110 is also configured to capture information on various process owners on the Knowledge Artifact and enable determination of Process Ownership Index (POI) by the rules engine 112. The rules engine 112 determines establishment of the process ownership and assigns a score of ‘0’, ‘1’ or ‘2’ based on the determination. In one implementation, the rules engine 112 assigns POI a score of ‘1’ when the process ownership is not established, a score of ‘1’ when the process ownership is partially established and a score of ‘2’ when the process ownership is established.

### Sourcing Flexibility Index (SFI)

Sourcing flexibility is a measure of flexibility of the knowledge that is being sourced into the one or more knowledge artifacts 212. Information on the Knowledge artifacts 212 gets sourced through multiple channels and multiple users. Such information is saved in the Knowledge Repository 104. The Rule Engine module 112 executes certain pre-defined rules in the system 100 in synchronization with business services module 114 to determine the flexibility of the knowledge that is being sourced into the knowledge artifacts. A survey is launched using the Knowledge repository interface 116 to capture user feedback on the ease of contributing to the knowledge artifact 212 and the ease of implementation of their contribution on the knowledge artifact 212. The results of the survey are captured by the business services module 114 and saved to the knowledge repository 104. The rules engine 112 determines the sourcing flexibility index based on the number of users ‘u’ who contributed to the knowledge artifacts 212, number of modifications ‘m’ to the knowledge artifact 212, average response on ease of contribution ‘x’ and average response on ease of implementation of the contribution ‘y’. For example, the rules engine 112 determines the sourcing flexibility index as mentioned below:

Sourcing Flexibility Index (SFI)=(m+x+y)/u

### Knowledge Risk Index (KRI)

The governance processing module 110 will identify the potential risk associated with a Knowledge artifact for usage of the artifact. All processes are monitored continuously for adherence to quality and any risks or deviations are immediately addressed and rectified. In one implementation, the governance processing module 110 identifies high, medium and low risk areas and pain points, performs tracking, monitoring and reporting of deviations and observes all Quality aspects. Good risk monitoring and control processes provide information that assists with making effective decisions in advance of the risk's occurring. The purpose of monitoring risk is to determine if:
Risk responses have been executed as planned
Risk response actions are as effective as expected or if new responses need to be developed
Proper policies and procedures are in place and are followed

Potential conflicts to the information provided in the knowledge artifact 212, the ownership of the knowledge artifact 212 and the risks associated with bringing unauthenticated or unverified information is assessed by the business service module 114 by executing a set of pre-defined rules in the rule engine 112. Any mal-formed content highlighted by the governance processing module 110.

The rules engine 112 determines the KRI and assigns a score of ‘0’ for high risk, ‘1’ for medium risk and ‘2’ for low risk. Examples of typical risks are indicated below:

| Track | Typical Risks | Mitigation and Examples |
|---|---|---|
| Knowledge | Scope not verified | Governance Owner performs a “due |
| Artifact | | diligence” activity to verify the scope |
| | | assumptions of Knowledge Artifact. One of |
| | | the main tasks is to verify |
| | | whether the Knowledge Artifact is |
| | | complete, |
| | | whether there are any obsolete |
| | | Knowledge artifacts in the system, |
| | | whether IP Control details on the |
| | | Knowledge artifact are accurate. |
| | Key Knowledge | Identifying key knowledge artifact subject |
| | artifact subject | areas is essential to ensure that all critical |
| | areas not finalized | processes are properly governed and exact |
| | | owners of the key areas are identified. |
| | Absence of | In-flight Knowledge Artifacts, continuing |
| | enhancements | enhancements lengthen the time of freeze. |
| | freeze on | Knowledge Governance owner ensures that |
| | knowledge artifact | enhancements are limited to only business |
| | | critical activities |
| | No planned way of | Though multiple areas can be covered in one |
| | measuring | single artifact which reflects knowledge |
| | Knowledge | acquired by the users, it is very important to |
| | effectiveness | get a comfort feel on length and effectiveness |
| | | of the Knowledge artifact. |
| Helpdesk | Delay in setting up | Knowledge Governance Owner will |
| | help desk | identify whether there are owners |
| | environment | associated with the various areas within |
| | | the knowledge artifact and if there is |
| | | contact information or a way to support |
| | | the queries on the knowledge artifact listed |
| | | Knowledge Governance owner establishes |
| | | the fact whether or not there are experts |
| | | within the organization who own a |
| | | particular Knowledge area |
| | Ineffective change | Adopt proactive change management to: |
| | management | Develop the change procedures, review |
| | | and approve |
| | | Make effective communication to end |
| | | users and publish enough up front and |
| | | appropriate planning after approval. |
| | | Effective training on the new tool and |
| | | procedures |
| Infrastructure | Delayed upgrade | Verifies whether the capacity of |
| | of link bandwidth | communication link is sufficient to serve the |
| | | knowledge artifact over the internet. |
| | Providing access | Whether users are getting timely access to |
| | | applications, databases, servers, emails, |
| | | calendars and different environments for the |
| | | Knowledge Hub is a key element in ensuring |
| | | that the team gets hands-on knowledge about |
| | | the applications and communicates |
| | | effectively. |
| Process | Process change not | The process change needs to be managed to |
| | managed properly | ensure that it does not delay creation and |
| | | updating of Knowledge artifact. |
| People | Non-availability of | Ensure that incumbent IT team is available. |
| | existing team | |
| | Attrition in | Ensure that incumbent IT team is available. |
| | existing team | Monitor on attrition |
| | Loosely defined | Loosely defined roles and responsibilities on |
| | roles and | the knowledge artifact in the system could |
| | responsibilities | mean things falling through cracks and |
| | | transition delays. |

Based on the computed scores of POI, SFI, and KRI, the IP effectiveness index (IPI) score is determined. In one example, the IP effectiveness index (IPI) score is determined by multiplication factor of POI, SFI, and KRI as illustrated below:

IP Effectiveness Index (IPI)=POI*SFI*KRI (1)

The IPI score determined by the rules engine 112 is either ‘0’ or greater than ‘0’. If the value of POI or KRI is ‘0’, then IPI score is ‘0’ and the rules engine 112 determines that the one or more knowledge artifacts 212 has either no established process ownership or has a high risk for publishing and review by users and hence determines not eligible for publication. If the IPI score is greater than ‘0’, then the rules engine 112 determines that the one or more knowledge artifacts 212 is eligible for publication.

### Audit Rights Index (ARI)

Audit Rights index score is a measure of one or more parameters such as Trade Secrets (TrS), Innovative Process (InP), Rights on the document (RiT), Completeness of the Knowledge Artifact (Com), and Tradable Value Asset (TvA) of the Knowledge artifact. In one implementation, the audit rights index score is determined by the rules engine 112 based on the scores of TrS, InP, RiT, Com and TvA.

### Trade Secrets (TrS)

TrS is an indicative of existence of Trade Secrets in the one or more knowledge artifacts 212. Trade Secret is classified as any confidential and competitive business information that exists on a Knowledge artifact which can provide the organization with a competitive advantage. This includes information, including a formula, pattern, compilation, program, device, method, technique, or process, that derives independent economic value, actual or potential, from not being generally known to or readily ascertainable through appropriate means by other persons who might obtain economic value from its disclosure or use; and is the subject of efforts that are reasonable under the circumstances to maintain its secrecy. The rules engine 112 determines the existence of Trade Secrets in the one or more knowledge artifacts 212 and assigns a score of either ‘0’ or ‘1’ based on the determination. For example, if the rules engine 112 determines that Trade Secrets exists, then the TrS score is ‘0’, otherwise ‘1’.

### Innovative Process (InP)

InP is a measure of availability of Innovative processes. Innovative process is a unique idea that could lead to potential business of commercial value to the organization. The rules engine 112 determines the availability of Innovative processes and assigns a score of either ‘0’ or ‘1’ based on the determination. For example, if the rules engine 112 determines that Innovative processes is available, then the InP score is ‘0’, otherwise ‘1’.

### Rights on the Document (RiT)

RiT is a measure of rights acquired on the knowledge artifact 212 to prevent unauthorized usage of the knowledge artifacts 212 by unintended users. Acquired rights may include rights to open, read and modify the knowledge artifact 212. The rules engine 112 determines the acquiring of rights and assigns a score of either ‘0’ or ‘1’ based on the determination. For example, if the rules engine 112 determines that rights are acquired, then the RiT score is ‘0’, otherwise ‘1’.

### Completeness of the Knowledge Artifact (Com)

Com is a measure of completeness of knowledge artifacts 212. A checklist is followed to ensure that the knowledge artifact 212 is complete. The rules engine 112 determines the completeness of the knowledge artifact 212 based on the checklist.

Some of the checklist items are illustrated below:
Is there a comprehensive document retention and document destruction policy in place?
Are there registers/records of all the destroyed documents and the documents pending destruction?
Are the titles on the documents duly updated and the documents are indexed and organized as per logical groupings?
Are the documents easily retrievable?
Have the documents been placed in the system adhering to the information security policies?
Are the correct documents figuring in the search results?
Is there a disaster recovery policy in place for the records?
Are there mandatory document management compliance policies in place?
Are there rules implemented to monitor the access to sensitive documents to the degree required by industry standards?
Are there standards or procedures implemented to avoid duplicity of documents?
Is the records inventory accurate, up to date and reviewed on a regular basis?
Have the departments taken measures locally to ensure the reliability of their records?
Has the staff and the users received proper training in records management?
Are there procedures in place to prevent modifications being made to the stored information without detection?
Does the system have a secure record of all read-write access to the data?
Is there sufficient audit trail information collected and maintained?
Are the breaches of document confidentiality, loss of documents etc. recorded as security incidents and managed appropriately?
Are all users aware of their responsibilities regarding confidential documents?
Are there author groups (like Employee, Partner, Supplier, Others) been defined in your system for defining user access levels?
Are there document version control procedures and mechanisms in place with check-in/check-out functions, document locking, version history and content comparison?
Is there advanced search mechanism that queries document attributes including author information, workflow state, responsible department etc.
Does the system have automated workflows for approvals etc. for view, edit, create and download of documents by authorized personnel?
Is the system design flexible enough to adapt immediately to changes in rules?
Is there a single sign on facility available for seamless movement between various modules within the system
Are there groups identified which need to be given the right to email designated document types as attachments?

### Tradable Value Asset (TvA)

TvA of knowledge artifacts 212 is a measure of association of a price with the knowledge artifact 212. The rules engine 112 determines the existence tradable value and assigns a score of either ‘0’ or ‘1’ based on the determination. For example, if the rules engine 112 determines that tradable value exists, then the TvA score is ‘1’, otherwise ‘0’.

Based on the computed scores of TrS, InP, RiT, Com and TvA, the audit rights index score is determined. In one example, the audit rights index score is determined by multiplication factor of TrS, InP, RiT, Com and TvA as illustrated below:

Audit Rights Index (ARI)=TrS*InP*RiT*Com*TvA (2)

The ARI score determined by the rules engine 112 is either ‘0’ or ‘1’, if the ARI score is ‘1’, then the rules engine 112 determines that the one or more knowledge artifacts 212 is eligible for publication, or if the ARI score is ‘0’, then the rules engine 112 determines that the one or more knowledge artifacts 212 is not eligible for publication and has to blocked for publication.

### Collaboration Index (CoI)

Collaboration index is a derivative of Individual collaboration index (ICI), Team collaboration index (TCI), Networked collaboration index (NCI) and Real time collaboration index (RCI). In one implementation, the rules engine 112 determines the collaboration index score based on the scores of ICI, TCI, NCI and RCI.

### Individual Collaboration Index (ICI)

ICI is measure of conversations by individuals using tools like Email, Calendar, Scheduling and Tasks.

Individual collaboration Index (ICI)=Σconversations

### Team Collaboration Index (TCI)

TCI is measure of conversations by team or group of individuals in one or more channels like Profile, Workspace, Document Sharing, Project Management, and Discussions. A user needs to maintain his or her profile and needs a space to see what are the pending items in his/her inbox to act upon like a work list. A user would share documents with other users and needs a platform to do the same. Users are involved in various projects. A common dashboard for all the actors in a project to collaborate is the Project Management Collaboration Aspect. A user also discusses on a variety of topics with other members on the platform using a Discussions Service.

Team collaboration Index (TCI)=Σconversations

### Networked Collaboration Index (NCI)

NCI is a measure of conversations by all users in one or more channels like Bookmarks, Tags, Activity Streams, Wiki, Blog. Everyone in the organization is probably bookmarking frequently visited sites or sites that we like. Bookmarking helps the users to remember an application or search results that you can go back to. A tag as a keyword or label is strongly related to the context that the user is working on. Activity Streams is a list of recent activities performed by the user. Wiki for knowledge sharing between various users and Blog for idea generation on effective user adoption.

Networked collaboration Index (NCI)=Σconversations

Real time Collaboration Index (RCI)

RCI is a measure of conversation by users in real time environments such as Instant Messenger, Whiteboard, Desktop Sharing, Mashups and VOIP. Instant Messenger would help the users to be in touch without the need of a phone call. Whiteboarding is required to come onto a single platform for visual sharing of data. Desktop Sharing also helps visual sharing of data and would actually show other users, what you are seeing. Mashups combines data from multiple sources real time. VOIP requires organizational investment to a larger extent. However, if enabled, the users can talk to each other using a soft phone interactively.

Real time collaboration Index (RCI)=Σconversations

Based on the computed scores of ICI, TCI, NCI, and RCI, the collaboration index score is determined. In one example, the collaboration index (CoI) score is determined by multiplication factor of ICI, TCI, NCI, and RCI as illustrated below:

Fx=ICI+TCI+NCI+RCI

Collaboration Index (CoI)=Fx*(Fx−1)/2 (3)

### Quality Index (QuI)

Quality index (QuI) is a measure of quality on knowledge artifacts 212 and is determined based on one or more parameters including author groups (AgI), association of title (TiI), suggested usage (SuI), tag (Tag) and number of modifications (Mod).

### Author Groups Index (AgI)

AgI score is a measure of existence of author groups on the knowledge artifact 212. Author groups may include for example, Employee, Partner, Supplier, Others defined in the system for defining user access levels. The AgI score determined by the rules engine 112 is either ‘1’ or ‘2’, if the rules engine 112 determines that the author groups exists then AgI score is ‘1’, otherwise ‘2’.

### Title Index (TiI)

TiI score is a measure of existence of title to a document. TiI score is determined by the rules engine 112 based on the existence of title to the document, the TiI score may be either ‘1’ or ‘2’. In one implementation, if the rules engine 112 determines that the association of title to a document exists then TiI score is ‘1’, otherwise ‘2’.

### Suggested Usage Index (SuI)

SuI score is a measure of availability of Suggested usage information on the knowledge artifact that indicates to the users of the document as to how to use that knowledge artifact. Every knowledge artifacts comprises a section that clearly defines on how to use a knowledge artifact, the section is titled as “Suggested Usage”. In one implementation, if the rules engine 112 determines that the Suggested usage information is available, then SuI score is assigned as ‘1’, otherwise ‘2’.

### Tag

Tag score is indicative of existence of tag with keywords to enable easier search of knowledge artifacts. Every knowledge artifact must have keywords associated with the document. If keywords are not there and the keywords not tagged to the knowledge artifact, the knowledge artifact is not effectively retrieved and utilized. In one implementation, if the rules engine 112 determines that the knowledge artifact has been tagged with keywords, then TiI score is assigned as ‘1’, otherwise ‘2’.

### Mod

Mod indicates the number of modifications made in the knowledge artifact and is represented by ‘n’.

Based on the computed scores of AgI, TiI, SuI, Tag, and Mod, the quality index score is determined. In one example, the quality index (QuI) score is determined by addition of AgI, TiI, SuI, Tag, and Mod as illustrated below:

Quality Index (QuI)=AgI+TiI+SuI+Tag+Mod (4)

Upon determining the an Intellectual Property IP effectiveness index (IPI) score, an audit rights index (ARI) score, a collaboration index score, and quality index score in any order, the rules engine 112 determines as to whether there is any gap or ambiguity in the business rules associated with the one or more knowledge artifacts 212 and evaluates the business rules if there is gap.

In one embodiment, the rules engine 112 determines the one or more business rules 216 associated with the one or more knowledge artifacts 212 and compares the one or more determined business rules 216 with one or more predetermined business rules provided by the business services module 114, wherein the predetermined business rules are related to at least one of content, ownership and IP associated with the one or more knowledge artifacts 212. If any ambiguity or gap is determined, then the one or more knowledge artifacts 212 are sent back to the authors for analysis like editing and modification. For example, the authors may review the knowledge artifact for ambiguity and remove any ambiguous material. Alternatively, they can add more clarification on why the stated material is unique and not ambiguous within the context of the knowledge artifact. Upon modifying the knowledge artifact 212, the rules engine 112 determines the an Intellectual Property IP effectiveness index (IPI) score, an audit rights index (ARI) score, a collaboration index score, and quality index score in any order. If the rules engine 112 determines a no gap, then the rules engine 112 determines the governance effective index score.

### Governance Effectiveness Index (GeI)

The governance effectiveness index score is measure of how the knowledge is being governed across various aspect of IP, Audit rights, Collaboration and Quality on the knowledge artifact 212. The rules engine 112 determines the governance effectiveness index score of the one or more knowledge artifacts 212 based on the at least one of Intellectual Property IP effectiveness index (IPI) score, an audit rights index (ARI) score, a collaboration index score, and quality index score. In one implementation, the governance effectiveness index score is determined by the rules engine 112 as illustrated below

Governance Effectiveness Index (GeI)=IPI*ARI*CoI*QuI (5)

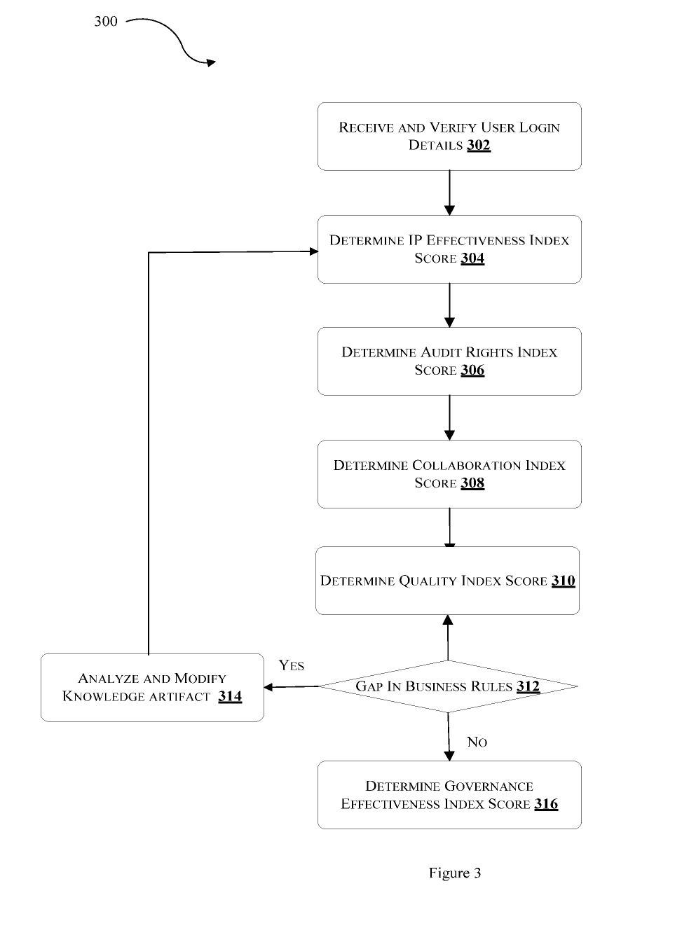

FIG. 3 illustrates a flowchart of method of determining governance effectiveness index score of the knowledge artifacts in accordance with an embodiment of the present disclosure.

As illustrated in FIG. 3, the method 300 comprises one or more blocks implemented by the rules engine 102 for determining governance effectiveness index score of the one or more knowledge artifacts 212. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

The method 300 relates to determination of governance effectiveness of knowledge artifacts. Let us consider an example, an organization named Gamma Cooks who manufacture frying pans would like to determine governance effectiveness of related knowledge artifacts. The organization did a research on social and other media and captured data that resulted in identifying that customers were looking forward to buy a Solar Frying Pan if available in the market. The organization created a knowledge artifact on what common people think of a Solar Frying Pan. According to the organization Gamma Cooks the bottom of the frying pan can have a specific metal prepared as a conglomeration of multiple elements that can form a frying pan there-by reducing the electricity consumption by 40% and frying in 50% lesser time.

The method 300 proceeds with verifying user login details and authorized with one or more access controls to access the Knowledge repository. The user may be for example, Employee at Gamma Cooks.

At block 302, receive and verify user login details. In one embodiment, the user interface module 108 is configured to validate a user who wishes to access or collaborate on the one or more knowledge artifacts. In one embodiment, the user interface module 108 receives the login details or the user account information 218 of a user and authenticates the user to access one or more knowledge artifacts based on valid login information. The users are authenticated by comparing the user account information 218 received from the user with login information previously stored at the time of registering the users. Upon validating the authenticity of the user, the user interface module 108 categorizes or classifies the user into one or more categories. Each categorized user may be assigned with one or more access controls determined by the rules engine 112 on the one or more knowledge artifacts. As per the illustration, the Employee is authenticated and authorized with access controls to publish the knowledge artifact.

At block 304, determine IP effectiveness index score. In one embodiment, the technology governance index score is a measure of effectiveness of the one or more knowledge artifacts in terms of IP. In one implementation, the IP effectiveness index score is determined by the rules engine 112 based on one or more parameter including Completeness of process ownership, Ease of Sourcing Flexibility and Risk associated with the one or more knowledge artifacts 212. The rules engine 112 determines establishment of the process ownership and assigns a score of ‘0’, ‘1’ or ‘2’ based on the determination. As per the example, the manufacturer will not be confidently publish the knowledge artifact to the market since the knowledge artifact may contain IP related information and hence the governance processing module 110 determines the process ownership. In one implementation, the rules engine 112 assigns POI a score of ‘1’ when the process ownership is not established, a score of ‘1’ when the process ownership is partially established and a score of ‘2’ when the process ownership is established.

The rules engine 112 determines the sourcing flexibility index based on the number of users ‘u’ who contributed to the knowledge artifacts 212, number of modifications ‘m’ to the knowledge artifact 212, average response on ease of contribution ‘x’ and average response on ease of implementation of the contribution ‘y’. Information on the Knowledge artifacts gets sourced through multiple channels and multiple users. Such information is saved in the Knowledge Repository. By default the author of the document is considered as a contributor for the knowledge artifact, hence sourcing flexibility index can never be 0.

There are many conversations happening on the knowledge artifact. Such conversations are monitored. The average response time taken by a user is taken into account towards contribution. A survey is launched using the Knowledge Portal to capture user feedback on the ease of contributing to the knowledge artifact and the ease of implementation of their contribution on the knowledge artifact.

Sourcing Flexibility Index (SFI)=(m+x+y)/u

As per the example, let us consider 10 users contributed to the knowledge artifact Solar frying pan (u) and there were 100 modifications on the document (m). A survey is rolled out to the user.

### Ease of Contribution Survey

Q1. How easy was it for you to contribute to the knowledge artifact: Easy/Moderately Difficult/Difficult

Easy has a score of 100, Moderately Difficult has a score of 50, Difficult has a score of 0. Let us assume, user has chosen Easy as the option. The same survey also captures the ease of implementation.

Q2. How easy would it be for the organization to implement changes recommended by you: Easy/Moderately Difficult/Difficult

Easy has a score of 100, Moderately Difficult has a score of 50, Difficult has a score of 0. Let us assume, user has chosen Moderately Difficult as the option. So, in this example: m=100, x=100, y=50, u=10

The rules engine 112 determines the sourcing flexibility index as mentioned below:

Sourcing Flexibility index=(100+100+50)/10=25

The higher the Sourcing Flexibility Index, the easier it is to source the document. The ease of sourcing a document is a direct co-relation on the effectiveness of the process or governance implemented.

The rules engine 112 further determines the KRI and assigns a score of ‘0’ for high risk, ‘1’ for medium risk and ‘2’ for low risk. The governance processing module 110 identifies the potential risk associated with a knowledge artifact for usage of the artifact. All processes are monitored continuously for adherence to quality and any risks or deviations are immediately addressed and rectified.

Below is a sample table that identifies the value of this parameter. These questions have to be answered by the author of the document in the knowledge artifact.

| S. | | | | |
|---|---|---|---|---|
| No | Question | Yes | Partial | No |
| A01 | Is Scope Verified | 100 | 0 | 0 |
| A02 | Key Knowledge artifact subject areas | 100 | 0 | 0 |
| | finalized | | | |
| A03 | Enhancements Frozen | 100 | 50 | 0 |
| A04 | Is there a planned way to measure | 100 | 50 | 0 |
| | knowledge effectiveness | | | |
| A05 | Is the help desk process setup | 100 | 50 | 0 |
| A06 | Is the Change Management process | 100 | 0 | 0 |
| | established | | | |
| A07 | Are there Subject Matter experts related | 100 | 0 | 0 |
| | to the subject mentioned in the | | | |
| | Knowledge Artifact | | | |
| A08 | Is there attrition in the current team | 100 | 50 | 0 |
| A09 | Are roles and responsibilities well defined | 100 | 50 | 0 |
| A10 | Has the knowledge artifact been access | 100 | 0 | 0 |
| | controlled | | | |

The rules engine will look at these questions and will suggest the governance processing module 110 on the score achieved. The final score from this is calculated as below

Knowledge Risk Index=A01*A02*A03* . . . *A10

As per the table, Possible Values of Low Risk may be 10*100=1000, High Risk may be 0 and anything in-between 0 and 1000 is Medium risk.

Based on the computed scores of POI, SFI, and KRI, the IP effectiveness index (IPI) score is determined. In one example, the IP effectiveness index (IPI) score is determined by multiplication factor of POI, SFI, and KRI as illustrated below:

IP Effectiveness Index (IPI)=POI*SFI*KRI

The IPI score determined by the rules engine 112 is either ‘0’ or greater than ‘0’. If the value of POI or KRI is ‘0’, then IPI score is ‘0’ and the rules engine 112 determines that the one or more knowledge artifacts 212 has either no established process ownership or has a high risk for publishing and review by users and hence determines not eligible for publication. If the IPI score is greater than ‘0’, then the rules engine 112 determines that the one or more knowledge artifacts 212 is eligible for publication.

At block 306, determine audit rights index score. Process governance index score is a measure of one or more parameters such as Trade Secrets (TrS), Innovative Process (InP), Rights on the document (RiT), Completeness of the Knowledge Artifact (Com), and Tradable Value Asset (TvA) of the Knowledge artifact. In one implementation, the audit rights index score is determined by the rules engine 112 based on the scores of TrS, InP, RiT, Com and TvA.

The rules engine 112 determines the existence of Trade Secrets in the one or more knowledge artifacts 212 and assigns a score of either ‘0’ or ‘1’ based on the determination. For example, the rules engine 112 determines whether the knowledge artifact of manufacturing solar frying pan comprises any Trade secrets which must not be available for publication and assigns TrS score based on the determination. In one implementation, if the rules engine 112 determines that Trade Secrets exists, then the TrS score is ‘0’, otherwise ‘1’.

The rules engine 112 determines the availability of Innovative processes and assigns a score of either ‘0’ or ‘1’ based on the determination. For example, the rules engine 112 determines the availability of Innovative processes involved in manufacturing Solar frying pan and assigns the score InP based on determination. In one implementation, if the rules engine 112 determines that Innovative processes are available, then the InP score is ‘0’, otherwise ‘1’. The rules engine 112 determines the acquiring of rights and assigns a score of either ‘0’ or ‘1’ based on the determination. For example, if the rules engine 112 determines that rights are acquired, then the RiT score is ‘0’, otherwise ‘1’.

Further, the rules engine 112 determines the completeness (Com) of the knowledge artifact 212. For example, the rules engine 112 determines whether all information related to solar frying pan is provided in the knowledge artifact 212 and assigns Com score based on determination. In one implementation, the rules engine 112 determines the existence tradable value and assigns a score of either ‘0’ or ‘1’ based on the determination. Further, the rules engine 112 determines the existence of tradable value (TvA). For example, the rules engine 112 determines whether any tradable value is related to manufacturing of solar frying pan and assigns TvA score based on determination. In one implementation, if the rules engine 112 determines that tradable value exists, then the TvA score is ‘1’, otherwise ‘0’.

Based on the computed scores of TrS, InP, RiT, Com and TvA, the audit rights index score is determined. In one example, the audit rights index score is determined by multiplication factor of TrS, InP, RiT, Com and TvA as illustrated below:

Audit Rights Index (ARI)=TrS*InP*RiT*Com*TvA

At block 308, determine collaboration index score. In one implementation, the collaboration index is a derivative of Individual collaboration index (ICI), Team collaboration index (TCI), Networked collaboration index (NCI) and Real time collaboration index (RCI). As per the example, the collaboration index score is determined based on the number of conversations made by users, manufacturer, team of people working on the manufacturing of solar frying pan etc. In one implementation, the rules engine 112 determines the collaboration index score based on the scores of ICI, TCI, NCI and RCI.

Individual collaboration Index (ICI)=Σconversations

Team collaboration Index (TCI)=Σconversations

Networked collaboration Index (NCI)=Σconversations

Real time collaboration Index (RCI)=Σconversations

Based on the computed scores of ICI, TCI, NCI, and RCI, the collaboration index score is determined. In one example, the collaboration index (CoI) score is determined by multiplication factor of ICI, TCI, NCI, and RCI as illustrated below:

Fx=ICI+TCI+NCI+RCI

Collaboration Index (CoI)=Fx*(Fx−1)/2

At block 310, determine quality index score. In one embodiment, the quality index is determined on one or more parameters including author groups (AgI), association of title (TiI), suggested usage (SuI), tag (Tag) and number of modifications (Mod).

The AgI score determined by the rules engine 112 is either ‘1’ or ‘2’, if the rules engine 112 determines that the author groups exists then AgI score is ‘1’, otherwise ‘2’. TiI score is determined by the rules engine 112 based on the existence of title to the document, the TiI score may be either ‘1’ or ‘2’. In one implementation, if the rules engine 112 determines that the association of title to the knowledge artifact related to solar frying pan exists then TiI score is ‘1’, otherwise ‘2’.

SuI score is a measure of availability of Suggested usage information on the knowledge artifact that indicates to the users of the document as to how to use that knowledge artifact. In one implementation, if the rules engine 112 determines that the Suggested usage information is available, then SuI score is assigned as ‘1’, otherwise ‘2’.

Tag score is indicative of existence of tag with keywords to enable easier search of knowledge artifacts. For example, the rules engine 112 determines existence of tag with keywords like frying pan, solar, electricity consumption, power saving, etc. and determines the Tag score based on the existence of tag. In one implementation, if the rules engine 112 determines that the knowledge artifact has been tagged with keywords, then Tag score is assigned as ‘1’, otherwise ‘2’.

Mod indicates the number of modifications made in the knowledge artifact and is represented by ‘n’.′

Based on the computed scores of AgI, TiI, SuI, Tag, and Mod, the quality index score is determined. In one example, the quality index (QuI) score is determined by addition of AgI, TiI, SuI, Tag, and Mod as illustrated below:

Quality Index (QuI)=AgI+TiI+SuI+Tag+Mod

At block 312, it is determined as to whether there is a gap in between one or more predetermined rules related to at least one of content, ownership and IP associated with the one or more knowledge artifacts. Upon determining the an Intellectual Property IP effectiveness index (IPI) score, an audit rights index (ARI) score, a collaboration index score, and quality index score in any order, the rules engine 112 determines as to whether there is any gap or ambiguity in the business rules associated with the one or more knowledge artifacts 212 and evaluates the business rules if there is gap.

In one embodiment, the rules engine 112 determines the one or more business rules 216 associated with the one or more knowledge artifacts 212 and compares the one or more determined business rules 216 with one or more predetermined business rules provided by the business services module 114, wherein the predetermined business rules are related to at least one of content, ownership and IP associated with the one or more knowledge artifacts 212. If a gap is determined, then the method proceeds to block 314 along the ‘YES’ path, otherwise proceeds to block 316 along the ‘NO’ path. For example, if the business strategies related to the knowledge artifact of manufacturing solar frying pan with desired characteristics of bottom of the pan is determined to have ambiguity, i.e., the business strategies in terms of bottom specifications is compared against industry standard expertize, then the rules engine 112 determines a gap based on the comparison and sets the score as ‘1’ or ‘0’.

At block 314, analyze and modify knowledge artifacts. In one embodiment, if it is determined that there is ambiguity or gap at block 312, then the method proceeds to analyze the knowledge artifact 212. One or more knowledge artifacts 212 are sent back to the authors for analysis like editing and modification. For example, the authors or the manufacturer of the frying pan may review the knowledge artifact for ambiguity and remove any ambiguous material. Alternatively, they can add more clarification on why the stated material is unique and not ambiguous within the context of the knowledge artifact. Upon modifying the knowledge artifact 212, the rules engine 112 determines the an Intellectual Property IP effectiveness index (IPI) score, an audit rights index (ARI) score, a collaboration index score, and quality index score in any order.

If the rules engine 112 determines a no gap, then the rules engine 112 proceeds to determine the governance effective index score.

At block 316, determine knowledge governance effectiveness index score. In one implementation, the governance effectiveness index score is measure of how the knowledge is being governed across various aspect of IP, Audit rights, Collaboration and Quality on the knowledge artifact 212. The rules engine 112 determines the governance effectiveness index score of the one or more knowledge artifacts 212 based on the at least one of Intellectual Property IP effectiveness index (IPI) score, an audit rights index (ARI) score, a collaboration index score, and quality index score. In one implementation, the governance effectiveness index score is determined by the rules engine 112 as illustrated below

Governance Effectiveness Index (GeI)=IPI*ARI*CoI*QuI

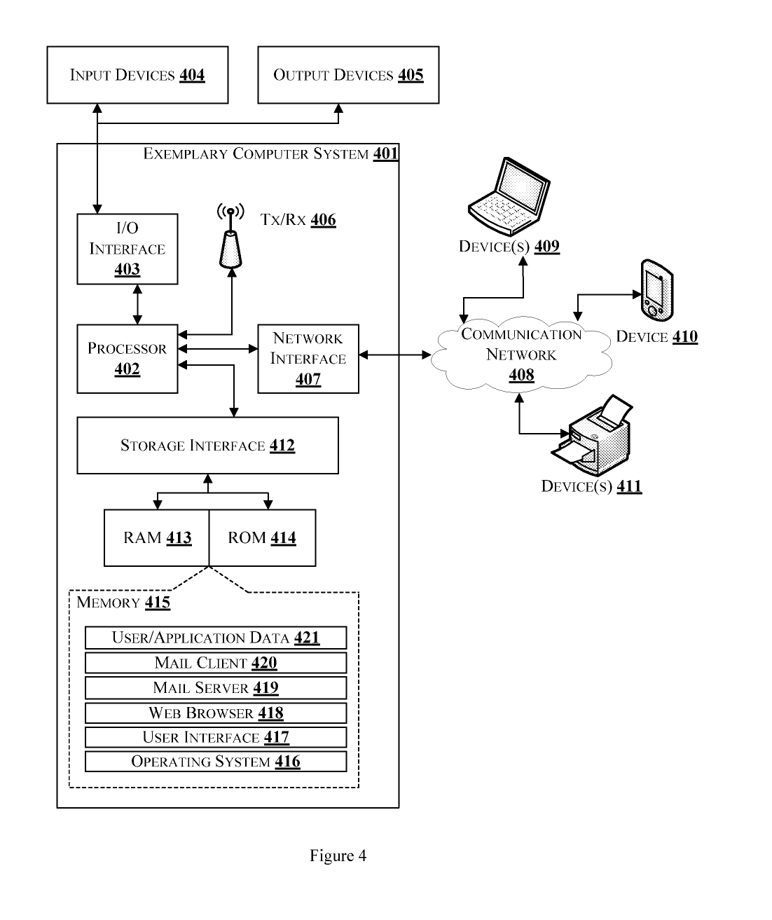

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

The specification has described a method and a system for determining lifecycle integrity of knowledge artifacts. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of determining governance effectiveness of a knowledge management system comprising:
accessing, by a governance management computing device, at least one metadata associated with one or more knowledge artifacts from a knowledge repository;
determining, by the governance management computing device, at least one of an Intellectual Property IP effectiveness index (IPI) score, an audit rights index (ARI) score, a collaboration index score, or a quality index score using the at least one metadata associated with the one or more knowledge artifacts; and
determining, by the governance management computing device, a governance effectiveness index score of the knowledge management system based on the at least one of the IP effectiveness index score, the audit rights index score, the collaboration index score, or the quality index score.

2. The method as claimed in claim 1, wherein the IP effectiveness index (IPI) score is determined based on one or more parameters comprising a Process Ownership Index (POI) score, a sourcing flexibility index (SFI) score, or a knowledge risk index score of the one or more knowledge artifacts.

3. The method as claimed in claim 1, wherein the audit rights index (ARI) score is determined based on one or more parameters comprising a Trade Secrets (TrS) existence score, an Innovative Process (InP) existence score, a Rights (RT) acquire score, a Knowledge Artifact Completeness (Com) score, or a Tradable Value of Knowledge Artifact (TvA) score of the one or more knowledge artifacts.

4. The method as claimed in claim 1, wherein the collaboration index (CoI) score is determined based on one or more parameters comprising an Individual Collaboration index (ICI) score, a Team Collaboration index (TCI) score, a Networked Collaboration index (NCI) score, or a Real time Collaboration index (RCI) score of the one or more knowledge artifacts.

5. The method as claimed in claim 1, wherein the quality index (QuI) score is determined based on one or more parameters comprising an Author groups existence index (AgI) score, a Title existence index (TiI) score, a Suggested usage index (SuI) score, a Tag score (Tag), or a Modifications score (Mod) of the one or more knowledge artifacts.

6. The method as claimed in claim 1, wherein upon determining the IP effectiveness index score (IPI), the audit rights index (ARI) score, the collaboration index (CoI) score, and the quality index (QuI) score, the method further comprises:
determining, by the governance management computing device, a gap between one or more predetermined rules related to at least one of content, ownership, or IP associated with the one or more knowledge artifacts;
analyzing, by the governance management computing device, at least one of the content, ownership, or IP associated with the one or more knowledge artifacts based on the determined gap; and
calculating by the governance management computing device, at least one of the IP effectiveness index score (IPI), the audit rights index (ARI) score, the collaboration index (CoI) score, or the quality index (QuI) score based on the analyzing.

7. The method as claimed in claim 1, wherein accessing the knowledge repository comprises:
receiving, by the governance management computing device, user information from a user;
determining, by the governance management computing device, a validity of the received user information by comparing the received user information with user information previously stored in the knowledge repository; and
providing, by the governance management computing device, one or more access control rights to the user for accessing the knowledge repository based on the validity determination.

8. A governance management computing device comprising:
a processor; and
a memory coupled to the processor which is configured to be capable of executing programmed instructions comprising and stored in the memory to:
access at least one metadata associated with one or more knowledge artifacts from a knowledge repository;
determine at least one of an Intellectual Property IP effectiveness index (IPI) score, an audit rights index (ARI) score, a collaboration index score, or a quality index score using the at least one metadata associated with the one or more knowledge artifacts; and
determine a governance effectiveness index score of the knowledge management system based on the at least one of the IP effectiveness index score, the audit rights index score, the collaboration index score, or the quality index score.

9. The device as claimed in claim 8, wherein the IP effectiveness index (IPI) score is determined based on one or more parameters comprising a Process Ownership Index (POI) score, a sourcing flexibility index (SFI) score, or a knowledge risk index score of the one or more knowledge artifacts.

10. The device as claimed in claim 8, wherein the audit rights index (ARI) score is determined based on one or more parameters comprising a Trade Secrets (TrS) existence score, an Innovative Process (InP) existence score, a Rights (RT) acquire score, a Knowledge Artifact Completeness (Com) score, or a Tradable Value of Knowledge Artifact (TvA) score of the one or more knowledge artifacts.

11. The device as claimed in claim 8, wherein the collaboration index (CoI) score is determined based on one or more parameters comprising an Individual Collaboration index (ICI) score, a Team Collaboration index (TCI) score, a Networked Collaboration index (NCI) score, or a Real time Collaboration index (RCI) score of the one or more knowledge artifacts.

12. The device as claimed in claim 8, wherein the quality index (QuI) score is determined based on one or more parameters comprising an Author groups existence index (AgI) score, a Title existence index (TiI) score, a Suggested usage index (SuI) score, a Tag score (Tag), or a Modifications score (Mod) of the one or more knowledge artifacts.

13. The device as claimed in claim 8, wherein upon determining the IP effectiveness index score (IPI), the audit rights index (ARI) score, the collaboration index (CoI) score, or the quality index (QuI) score, the processor is further configured to be capable of executing programmed instructions comprising and stored in the memory to:
determine a gap between one or more predetermined rules related to at least one of content, ownership, or IP associated with the one or more knowledge artifacts;
analyze at least one of the content, ownership, or IP associated with the one or more knowledge artifacts based on the determined gap; and
calculate at least one of the IP effectiveness index score (IPI), the audit rights index (ARI) score, the collaboration index (CoI) score, or the quality index (QuI) score based on the analyzing.

14. The device as claimed in claim 8, wherein the processor is further configured to be capable of executing programmed instructions for accessing the knowledge repository comprising and stored in the memory to:
receive user information from a user;
determine a validity of the received user information by comparing the received user information with user information previously stored in the knowledge repository; and
provide one or more access control rights to the user for accessing the knowledge repository based on the validity determination.

15. A non-transitory computer readable medium having stored thereon instructions for determining governance effectiveness of a knowledge management system which when executed by a processor, cause the processor to perform steps comprising:
accessing at least one metadata associated with one or more knowledge artifacts from a knowledge repository;
determining at least one of an Intellectual Property IP effectiveness index (IPI) score, an audit rights index (ARI) score, a collaboration index score, or a quality index score using the at least one metadata associated with the one or more knowledge artifacts; and
determining a governance effectiveness index score of the knowledge management system based on the at least one of the IP effectiveness index score, the audit rights index score, the collaboration index score, or the quality index score.

16. The medium as claimed in claim 15, wherein the IP effectiveness index (IPI) score is determined based on one or more parameters comprising a Process Ownership Index (POI) score, a sourcing flexibility index (SFI) score, or a knowledge risk index score of the one or more knowledge artifacts.

17. The medium as claimed in claim 15, wherein the audit rights index (ARI) score is determined based on one or more parameters comprising a Trade Secrets (TrS) existence score, an Innovative Process (InP) existence score, a Rights (RT) acquire score, a Knowledge Artifact Completeness (Com) score, or a Tradable Value of Knowledge Artifact (TvA) score of the one or more knowledge artifacts.

18. The medium as claimed in claim 15, wherein the collaboration index (CoI) score is determined based on one or more parameters comprising an Individual Collaboration index (ICI) score, a Team Collaboration index (TCI) score, a Networked Collaboration index (NCI) score, or a Real time Collaboration index (RCI) score of the one or more knowledge artifacts.

19. The medium as claimed in claim 15, wherein the quality index (QuI) score is determined based on one or more parameters comprising an Author groups existence index (AgI) score, a Title existence index (TiI) score, a Suggested usage index (SuI) score, a Tag score (Tag), or a Modifications score (Mod) of the one or more knowledge artifacts.

20. The medium as claimed in claim 15, having stored thereon further instructions which when executed by the processor, cause the processor to, upon determining the IP effectiveness index score (IPI), the audit rights index (ARI) score, the collaboration index (CoI) score, or the quality index (QuI) score, perform steps further comprising:
determining a gap between one or more predetermined rules related to at least one of content, ownership, or IP associated with the one or more knowledge artifacts;
analyzing at least one of the content, ownership, or IP associated with the one or more knowledge artifacts based on the determined gap; and
calculating at least one of the IP effectiveness index score (IPI), the audit rights index (ARI) score, the collaboration index (CoI) score, or the quality index (QuI) score based on the analyzing.

21. The medium as claimed in claim 15, wherein accessing the knowledge repository comprises:
receiving user information from a user;
determining a validity of the received user information by comparing the received user information with user information previously stored in the knowledge repository; and
providing one or more access control rights to the user for accessing the knowledge repository based on the validity determination.
